(19) United States
(12) Patent Application Publication
(10) Pub. No.: US 2012/0051037 A1
(43) Pub. Date: Mar. 1, 2012

(54) STRUCTURE OF HOLDER OF LED LIGHTING TUBE

(75) Inventors: Ching Feng Lin, Taipei County (TW); Yung Han, Taipei County (TW)

(73) Assignee: JADE YANG CO., LTD., Taipei Conuty (TW)

(21) Appl. No.: 12/967,263

(22) Filed: Dec. 14, 2010

(30) Foreign Application Priority Data
Aug. 31, 2010 (TW) 099216860

(51) Int. Cl. F21V 21/00

(52) U.S. Cl. 362/217.14

(57) ABSTRACT

A structure of holder of LED lighting tube includes a holder body, two end sockets, and two retainers. The two end sockets are respectively mounted to two ends of the holder body and each of the end sockets forms an opening. The two retainers are respectively received in the end sockets, and each of the retainers has a central portion forming a longitudinal passage, which receives and retains therein a metal clip. As such, the arrangement of power supply inside the holder body is simplified, so that the holder body and the end sockets can be manufactured in an integrally-formed manner and the metal clips can be used to clamp an LED lighting tube to thereby improving manufacturing efficiency and reducing manufacturing costs, and facilitating easy mounting and dismounting of the LED lighting tube.

### BACKGROUND OF THE INVENTION

1. Field of the Invention

The present invention is related to a structure of holder of LED (Light-Emitting Diode) lighting tube, and more particular to a unitary structure realized through integrally forming a holder body and end sockets together so as to help improving manufacturing efficiency and reducing manufacturing costs, and also facilitate mounting and dismounting of an LED lighting tube, and thus being applicable to a lighting tube of for example an elongate LED lighting tube, a power-saving lighting tube or the likes.

2. Description of Related Art

A conventional fluorescent tube holder comprises a holder body inside which a circuit board is arranged. The circuit board carries a transformer and a constant-current power supply for transformation of electrical power and activation of the lighting tube to give off light. The holder body has two ends each forming an end socket that forms a receptacle to receive contacts of the lighting tube to be inserted therein and then rotated by 90 degrees for electrical engagement thereby allowing the lighting tube to be powered for giving off light. Further, through the receptacles, the lighting tube can be securely fixed on the holder body.

However, the fluorescent lighting tube is gradually replaced by an LED lighting tube. The conventional receptacles are not suitable for the LED lighting tube. The LED lighting tube often comprises an internal circuit board having one side carrying thereon a plurality of LED's and the other side carrying heat dissipation fins. An attempt to keep the conventional receptacle structure but changing a power circuit contained inside the holder body often leads to an embarrassing condition that due to the 90 degree rotation, an LED lighting tube, once inserted into the conventional receptacles of a tube holder, will be oriented in such a direction that an irradiating surface of the LED lighting tube is angularly shifted by 90 degrees, making it impossible to light the area located just below the LED lighting tube.

Further, some of the LED lighting tubes available in the market are provided with an internal circuit board that already carries a power conversion unit, such as a transformer, thereon so that there is no need to provide any power conversion device inside the holder body. However, this certainly increases the manufacturing costs of the LED lighting tubes and at the same time reduces the manufacturing efficiency thereof.

Thus, in view of the above problems, the present invention aims to provide a structure of holder of LED lighting tube, which helps reducing the manufacturing cost of LED lighting tubes and increasing the manufacturing efficiency thereof, and also facilitates easy mounting and dismounting of LED lighting tubes by users.

### SUMMARY OF THE INVENTION

Accordingly, the primary objective of the present invention is to provide a structure of holder of LED lighting tube, which is modified in such a way that a power conversion unit that is conventionally arranged inside a holder body is re-located to a front end portion of the tube holder in order to simplify the arrangement of the holder body, reduce the amount of space occupied by the holder body, and allow the holder body and end sockets to be designed and manufactured in an integrally-formed manner thereby improving overall manufacturing efficiency of the present invention.

The secondary objective of the present invention is to provide a structure of holder of LED lighting tube, wherein each of the end sockets receives a retainer therein and the retainer receives and retains a metal clip therein, each metal clip forming two positioning portions, which receive and clamp contacts of an LED lighting tube therein, so that there is no need for the LED lighting tube to be rotated 90 degrees for being secured and set in electrical engagement, and an advantage of easy mounting and dismounting of the LED lighting tube can be achieved to thereby improve the convenience of use of the present invention.

Another objective of the present invention is to provide a structure of holder of LED lighting tube, wherein the holder body has a side forming a slot, which receives and retains a shade plate fit therein to concentrate light, thereby improving the functionality and practicability of the present invention.

A further objective of the present invention is to provide a structure of holder of LED lighting tube, wherein the holder body comprises electrical connectors mounted to the ends thereof and connection can be made through a transmission cable to establish electrical connection between the holder body and another holder body for transmission of power therebetween so that transmission of power can be extended, thereby improving the functionality of the present invention.

In order to achieve the foregoing objectives, the present invention provides a structure of holder of LED lighting tube, which comprises a holder body, two end sockets, and two retainers. The two end sockets are respectively mounted to two ends of the holder body and each of the end sockets has a bottom forming an opening. The two retainers are respectively received in the end sockets, and each of the retainers has a central portion forming a longitudinal passage, which receives and retains therein a metal clip. Each of the metal clips forms two positioning portions. As such, the metal clip may receive and clamp an LED lighting tube to facilitate easy mounting and dismounting of the LED lighting tube.

### BRIEF DESCRIPTION OF THE DRAWINGS

The present invention can be fully understood from the following detailed description and preferred embodiments with reference to the accompanying drawings, in which:

FIG. 1 is a perspective view showing a first embodiment of the present invention;

FIG. 2 is another perspective view of the present invention showing an LED (Light-Emitting Diode) lighting tube detached from a tuber holder;

FIG. 3 is an exploded view, in an enlarged form, showing a portion of the tube holder according to the present invention;

FIG. 4 is a cross-sectional view of the present invention;

FIG. 5 is a perspective view showing a second embodiment of the present invention;

FIG. 6 is a perspective view showing a third embodiment of the present invention; and

FIG. 7 is an end view of the third embodiment of the present invention.

### DETAILED DESCRIPTION OF THE PREFERRED EMBODIMENTS

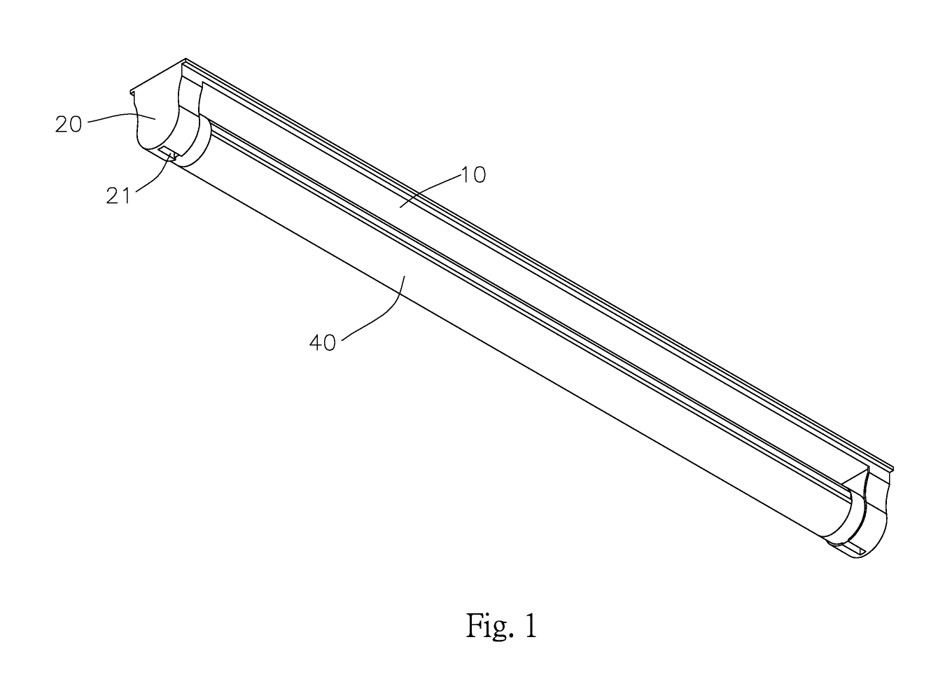

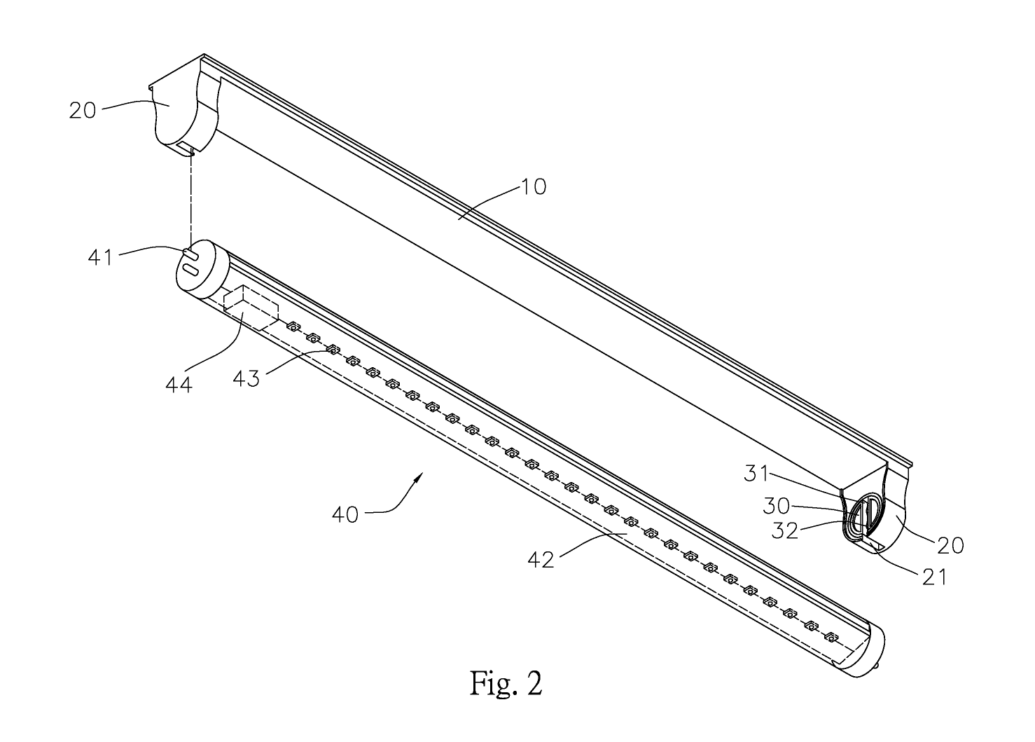

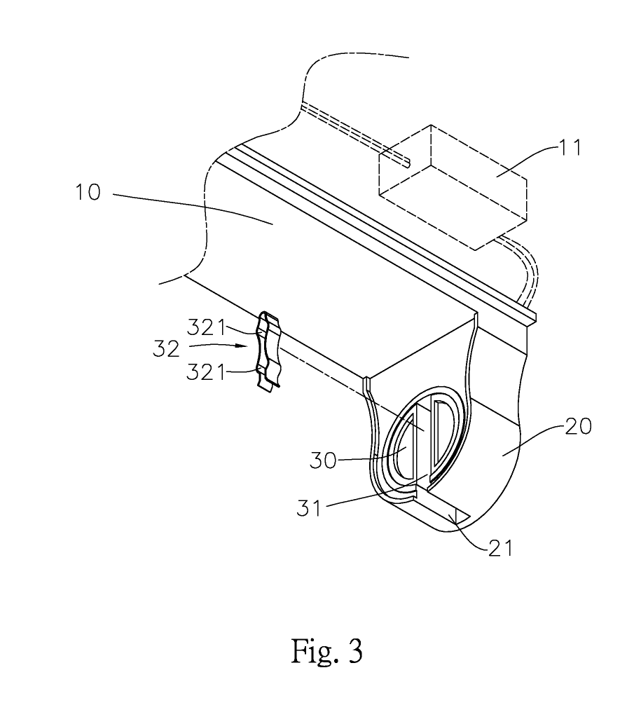

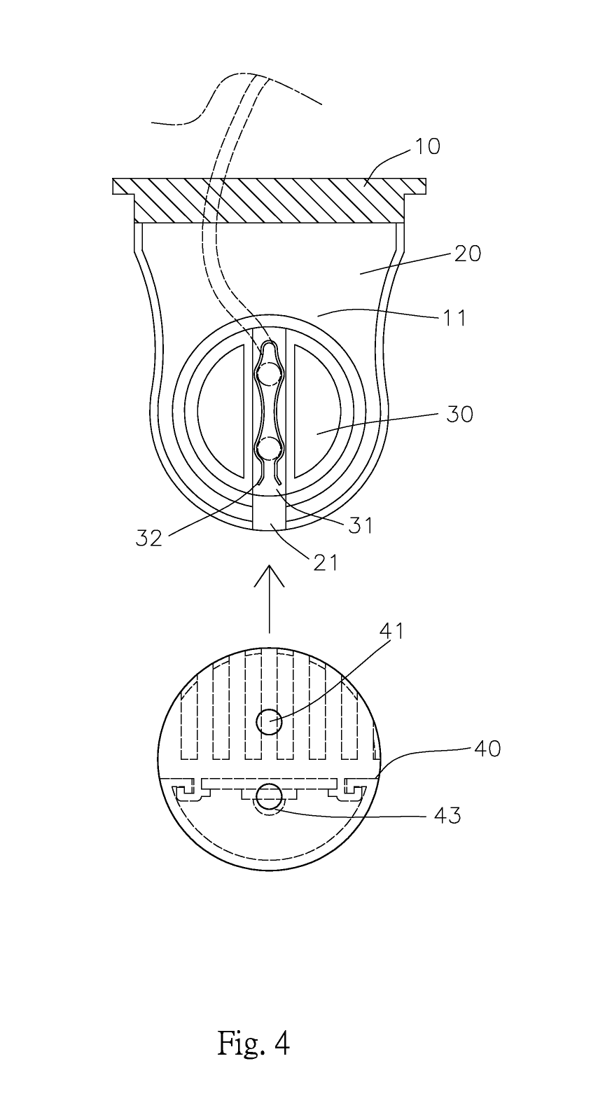

Referring to FIGS. 1-7, which show a first embodiment, a second embodiment, and a third embodiment of the present invention, the present invention provides a structure of holder of LED (Light-Emitting Diode) lighting tube, which comprises a holder body 10, two end sockets 20, and two retainers 30. The two end sockets 20 are respectively mounted at opposite ends of the holder body 10. Each of the end sockets 20 forms an opening 21 at a bottom side thereof. The two retainers 30 are respectively received in the end sockets 20. Each of the retainers 30 has a central portion forming a longitudinal passage 31, which receives and retains therein a metal clip 32. Each metal clip 32 has two positioning portions 321. As such, the metal clip 32 serve to clamp an LED lighting tube 40 to allow for easy mounting and dismounting of the LED lighting tube 40.

The holder body 10 comprises a power conversion unit (a transformer 11) that is positioned at and mounted outside a front end portion of the tube holder structure. The transformer 11 is electrically connected to the metal clips 32 received in the retainers 30 for supply of electrical power to the LED lighting tube 40. The transformer 11 can be positioned at any desired location according to the requirement of structural arrangement. Further, the holder body 10 and the two end sockets 20 are integrally formed as a unitary structure. The holder body 10 further comprises electrical connectors 12 respectively set at the ends thereof. The holder body receives therein a power transmission cable 13 that connects the electrical connectors 12 at the ends for transmission of electrical power. The electrical connectors 12 may be further provided with a transmission cable 60, through which electrical connection can be made with an electrical connector 12 of another holder body 10. The holder body 10 further forms slots 14 in opposite sides thereof for each receiving and retaining a shade plate 50. The metal clip 32 forms two positioning portions 321. The LED lighting tube 40 has two ends each forming contacts 41. The LED lighting tube 40 comprises therein a circuit board 42, which is electrically connected to the contacts 41. The circuit board 42 carries a plurality of LED's 43 and a current regulator 44 thereon. The plurality of LED's 43 is connected in series and further connected to the current regulator 44, so that the LED's 43 may give off light in a current-regulated condition. The holder body 10 further comprises hooks for wall mounting. The shade plates 50 may forms a metal surface through electroplating to facilitate reflection of light.

Referring to FIGS. 1-7, which show a first embodiment, a second embodiment, and a third embodiment of the present invention, the present invention provides a structure of holder of LED lighting tube, which, in a preferred embodiment, comprises a holder body 10 and two end sockets 20 that are integrally formed together as a unitary structure with the material used being plastics or other suitable materials. The holder body 10 is of an elongate and thin configuration and the two end sockets 20 are respectively mounted to opposite ends of the holder body 10. The two end sockets 20 are spaced from each other by a distance that substantially corresponds to a length of an LED lighting tube 40. Each of the two end sockets 20 forms therein a cavity in which a retainer 30 is received. The retainer 30 has a central portion forming a longitudinal passage 31. The end socket 20 forms an opening 21, which is in alignment with and communicates the longitudinal passage 31. The longitudinal passage 31 receives and retains therein a metal clip 32, which forms two positioning portions 321, each of which is composed of two halves that are located close to each other to form an O ring like structure for each of the positioning portions 321 of the metal clip 32 (wherein the clip 32 can be alternatively embodied as two connected strips each forming two spaced arc surfaces (not shown)). The holder body 10 comprises a power conversion unit (a transformer 11) that is positioned at and mounted outside a front end portion of the tube holder structure. The transformer 11 is electrically connected to the metal clips 32 received in the retainers 30 for supply of electrical power to the metal clips 32. The LED lighting tube 40 has two ends each forming contacts 41, which are respectively positive terminals and negative terminals at opposite ends of the LED lighting tube 40. The contacts 41 on two ends of the LED lighting tube 40 are receivable through the openings 21 defined in the bottoms of the two end sockets 20 and movable through the longitudinal passages 31 into the metal clips 32 so as to have the contacts 41 of the LED lighting tube 40 engaging and retained in the positioning portions 321, securely clamping the contacts 41 in the metal clips 32. Further, the LED lighting tube 40 comprises therein a circuit board 42, which is electrically connected to the contacts 41. The circuit board 42 carries a plurality of LED's 43 and a current regulator 44 thereon. The plurality of LED's 43 is connected in series and further connected to the current regulator 44, so that the LED's 43 may be operated in a current-regulated condition and thus give off light in a stable manner. This makes it unnecessary for the LED lighting tube 40 to be rotated 90 degrees before physically engaging the power source for activation. Further, this structural arrangement allows for easy mounting and dismounting of the LED lighting tube 40.

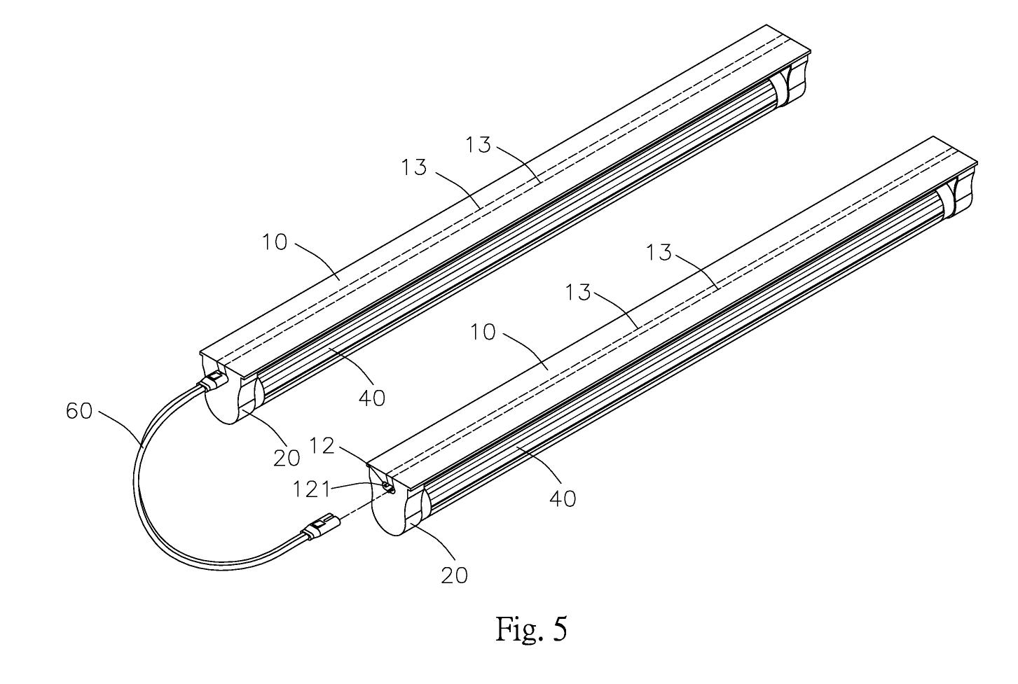

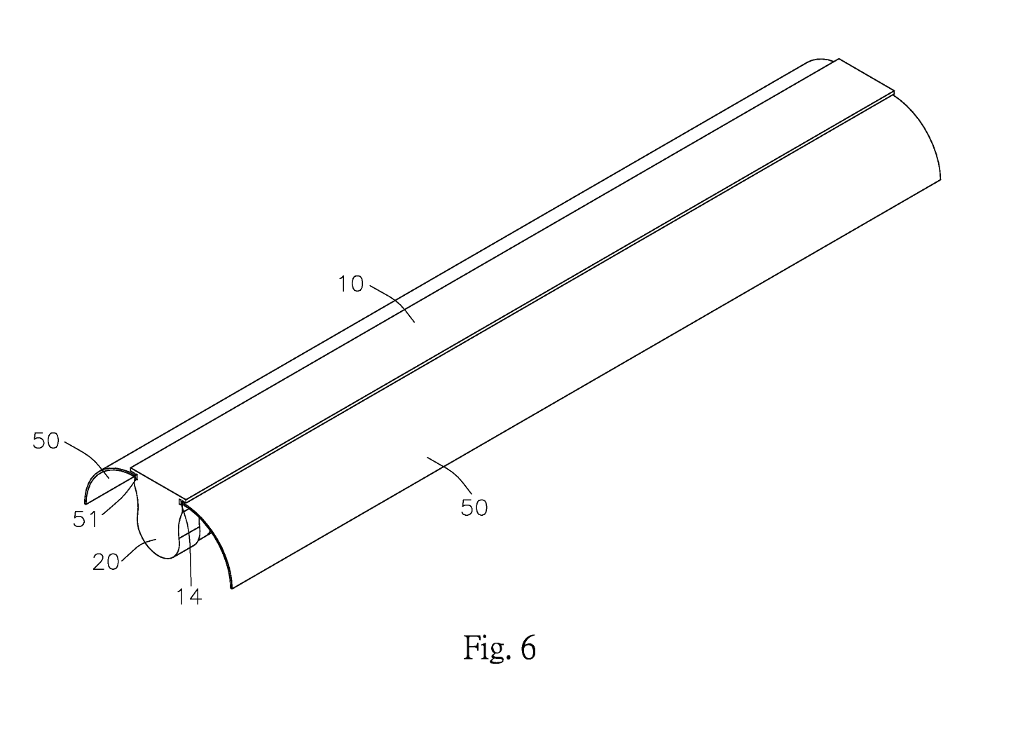

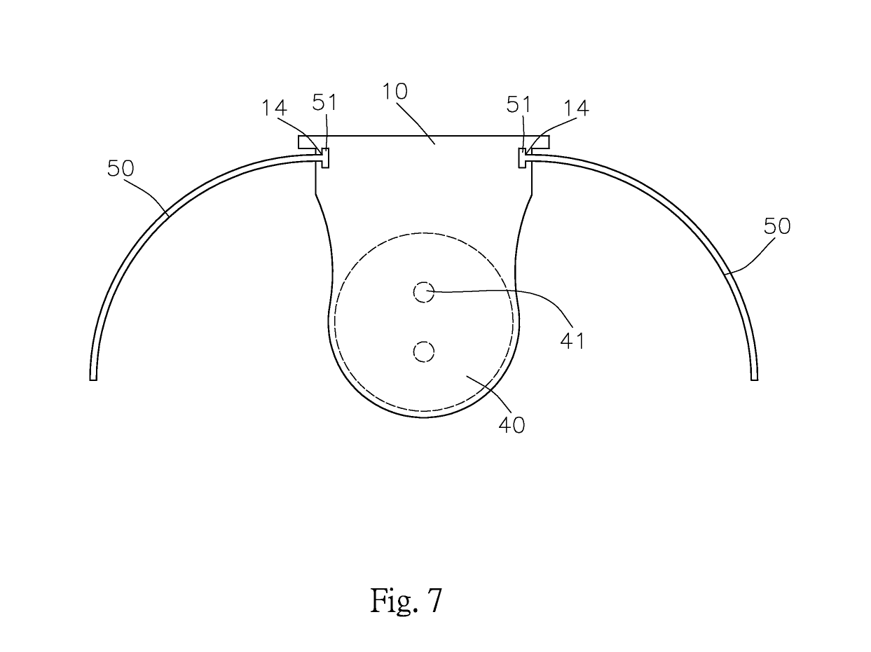

Further, in the second embodiment of the present invention (see FIG. 5), a holder body 10 has two ends to each of which an electrical connector 12 is mounted. The electrical connector 12 comprises two electrical terminals 121 arranged therein. Two power transmission cables 13 are arranged inside the holder body 10 and connect the electrical terminals 121 of the two ends. The electrical connectors 12 are further provided with a transmission cable 60 located outside the holder body 10 for selective connection between one of the electrical connectors 12 and a counterpart electrical connector 12 of another holder body 10, while the other one of the electrical connectors 12 may be connected with a plug (not shown), through which connection with a power socket or wall outlet may be made for transmission of electrical power, whereby the electrical connector 12 may receive and transmit alternate current (AC) power of 110V to the opposite electrical connector 12, which may selectively be connected with an external device (such as emergency light or electrical fan. In the third embodiment of the present invention (see FIGS. 6 and 7), a holder body 10 has two sides each forming a slot 14, which receives and retains a shade plate 50 fit therein. The shade plate 50 has one side forming a flange 51, which is fit into the slot 14 to make a form resembling a lampshade. The shade plate 50 may be selectively processed through electroplating so as to form a metal surface, which helps concentrating light and re-directing the light downward so as to improve irradiating area and brightness. In a fourth embodiment of the present invention (not shown in the drawings), a holder body 10 is provided with hooks that are fixed to a back side of the holder body 10 through bolts and the hooks function to mount the holder body to for example a ceiling or a wall.

In summary, the present invention provides the following advantages:

(1) Through the arrangement of retainers inside the end sockets and metal clips contained inside the retainers, the metal clips may receive and securely clamps contacts of an LED lighting tubes, so that there is no need to rotate the LED lighting tube by for example 90 degrees before the LED lighting tube can be securely mounted to the end sockets, whereby practicability and convenience can be improved.

(2) Through the arrangement of slots defined along sides of the holder body, shade plates may be selectively fit into and thus retained by the slots to form a lampshade, which helps reflecting light, whereby practicability can be improved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A structure of holder of LED (Light-Emitting Diode) lighting tube, comprising:
a holder body;
two end sockets, which are respectively mounted to two ends of the holder body, each of the end sockets having a bottom forming an opening; and
two retainers, which are respectively received in the end sockets, each of the retainers having a central portion forming a longitudinal passage, which receives and retains therein a metal clip, wherein the metal clip functions to receive and clamp an LED lighting tube to facilitate easy mounting and dismounting of the LED lighting tube.

2. The structure of holder of LED lighting tube according to claim 1, wherein the holder body comprises a transformer that is set outside a front end portion of the holder body, the transformer being electrically connected to the metal clips retained inside the retainers for supply of electrical power to the LED lighting tube.

3. The structure of holder of LED lighting tube according to claim 1, wherein the holder body and the two end sockets are integrally formed together as a unitary structure.

4. The structure of holder of LED lighting tube according to claim 1, wherein the holder body comprises an electrical connector mounted to each of the ends thereof, the holder body comprising a power transmission cable received therein for connection with the electrical connectors for transmission of electrical power, the electrical connectors being selectively connectable with a transmission cable, which extends transmission of electrical power to a counterpart electrical connector of another holder body.

5. The structure of holder of LED lighting tube according to claim 1, wherein the holder body has a side forming a slot for receiving and retaining a shade plate fit therein.

6. The structure of holder of LED lighting tube according to claim 1, wherein the metal clip forms a plurality of positioning portions.

7. The structure of holder of LED lighting tube according to claim 1, wherein the LED lighting tube has two ends each being provided with contacts, the LED lighting tube comprising a circuit board received therein, the circuit board being electrically connected to the contacts, the circuit board carrying thereon a plurality of light-emitting diodes and a current regulator, the light-emitting diodes being connected in series and further connected to the current regulator.

8. The structure of holder of LED lighting tube according to claim 1, wherein the holder body comprises hooks attached thereto for mounting the holder body to a wall.

9. The structure of holder of LED lighting tube according to claim 5, wherein the shade plate is processed with electroplating to form a metal surface that helps reflecting light.
